(19) United States
(12) Patent Application Publication
(10) Pub. No.: US 2010/0020294 A1
(43) Pub. Date: Jan. 28, 2010

(54) PROJECTION TYPE VIDEO DISPLAY APPARATUS

(75) Inventors: Shoji OKAZAKI, Gifu (JP); Toshihiro Saruwatari, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sanyo Electric Co., Ltd., Osaka (JP)

(21) Appl. No.: 12/572,666

(22) Filed: Oct. 2, 2009

Related U.S. Application Data
(63) Continuation of application No. 12/299,400, filed on Nov. 3, 2008.

(30) Foreign Application Priority Data
May 26, 2006 (JP) 2006-147102
Sep. 4, 2006 (JP) 2006-238463

(51) Int. Cl. G03B 3/00

(52) U.S. Cl. 353/101

(57) ABSTRACT

A projection type video display apparatus having a projection lens opening (3) formed in the front end (1a) of the apparatus and a lend adjustment opening (5) formed in one end adjacent the front end, both openings protected against dust and external mechanical shocks. The projection type video display apparatus is adapted to project an image that is generated by modulating light emitted from a light source based on video signals, through a projection lens unit (2) exposed in the projection lens opening (3). The apparatus comprises lens adjustment members (e.g. adjustment dial 4) for zooming and/or focusing the projection lens unit (2), and a cover mechanism (slide cover 7) for opening and closing the projection lens opening (3) and lend adjustment opening (5).

### CROSS-REFERENCE TO RELATED APPLICATIONS

This application is a Continuation of U.S. patent application Ser. No. 12/299,400, filed Nov. 3, 2008, and wherein application Ser. No. 12/299,400 is a national stage application filed under 35 USC §371 of International Application No. PCT/JP2007/060046, filed May 16, 2007, the contents of which are incorporated herein by reference in their entirety.

### TECHNICAL FIELD

This invention relates to a projection type video display apparatus such as a liquid crystal projector for displaying an image formed by modulating light emitted from a light source based on a picture signal and by projecting the modulated light through a projection lens unit exposed in a projection lens opening formed in the front end of a projector case.

### BACKGROUND ART

Projection type video display apparatuses of this kind are influenced by dust that is deposited on the exposed surface of the projection lens in the projection lens opening formed in the front end of the projector and by dust that enter the projector through an empty space around the projection lens unit during a period when the projector is not in use. Moreover, since the projection lens is vulnerable to a mechanical shock, it can be damaged if it is hit by something during transportation, for example.

In order to prevent such accidents, therefore, a projection lens is conventionally covered with a cap or protected by a cover that is slidable in the transverse direction to shut the opening. (See for example Patent Document 1 cited below.)

Patent Document 2, also cited below, discloses a projector case accommodating a projection lens unit and equipped with a detachable, slidable, or openable-and-closable cover to shut the front end of the case. References:

Patent Document 1 Japanese Patent Application Laid Open 11-64971 (G03B 21/00, G02F1/13)

Patent Document 2 Japanese Patent Application Laid Open 2002-344848 (H04N 5/74, G03B 21/00)

### DISCLOSURE OF THE INVENTION

### Problems to be Solved by the Invention

Generally, projection lens units are provided with a zooming and/or focusing function that is either electronically operable (in a high-end model) or manually operable (in a low-end model).

In the case of manually operable one, it is preferable, for ease of manual adjustment of the projection lens, to form an opening in the upper end of the case (the opening hereinafter referred to as lens adjustment opening) adjacent the front end thereof for exposing lens adjustment members such as an adjustment dial.

However, the lens adjustment openings formed in the upper end of the case as described above cannot be closed with a lid or cover of the Patent Documents 1 and 2. As a consequence, the projection lens unit cannot be protected against dust depositing in opening, or against an external mechanical shock from outside the opening.

In view of such prior art problems as stated above, this invention seeks to provide a projection type video display apparatus having a projection lens unit protected against dust and external mechanical shocks from outside a projection lens opening formed in the front end of the case and a lens adjustment opening formed in one end of the case adjacent the front end.

### Means for Solving the Problem

To this end, the present invention as defined in claim 1 provides a projection type video display apparatus adapted to project an image that is generated by modulating light emitted from a light source based on video signals, through a projection lens unit exposed in a projection lens opening formed in the front end of the case of the apparatus, the video display apparatus comprising:

a lens adjustment opening formed in one end of the case adjacent the front end to expose therein lens adjustment members for zooming and/or focusing the projection lens unit; and

a cover mechanism for simultaneously closing and opening the projection lens opening and lens adjustment opening.

In one aspect of the invention as defined in claim 2,

the lens adjustment opening is conformed to the lens adjustment members that are exposed in the lens adjustment opening and operable in the transverse direction; and

the cover mechanism has a slide cover that has an inverted L-shape cross section and is freely slidable in the transverse direction to cover the front projection lens opening and the upper lens adjustment opening.

In another aspect of the invention as defined in claim 3, the cover mechanism is made of a transparent or translucent material.

In a still another form of the invention as defined in claim 4, the cover mechanism has a slide holder capable of holding the slide cover so as to keep open the projection lens opening and lens adjustment opening.

In a further aspect of the invention as defined in claim 5, the slide holder is capable of holding the slide cover so as to keep closed the projection lens opening and lens adjustment opening.

In a still further aspect of the invention as defined in claim 6, the cover mechanism has a slide holder capable of holding the slide cover so as to keep the projection lens opening and lens adjustment opening closed.

In a still further aspect of the invention as defined in claim 7, the projection lens opening and lens adjustment opening are formed separate from each other.

In a still further aspect of the invention as defined in claim 8, the slide holder is provided on the surface thereof facing the inside of the case with a protruding rail that extends in the sliding direction of the slide cover, and securely fixed on the case. Further, the slide cover has an elongate groove having an open end and adapted to engage with the protruding rail of the slide holder so as to hold the slide cover freely slidable between the slide holder and the case.

In a still further aspect of the invention as defined in claim 9, the slide cover is provided at the open end of the elongate groove with a resilient pawl that is capable of engaging with a stopper formed on the slide holder so as to keep the projection lens opening and lens adjustment opening closed.

In a still further aspect of the invention as defined in claim 10, the slide cover is provided with a recess that is formed in one end of the slide cover remote from the open end of the elongate groove and has at the open end of the recess a resilient pawl that is capable of engaging with a stopper formed on the slide holder so as to keep the projection lens opening and lens adjustment opening open.

### MERITS OF THE INVENTION

In accordance with the invention as defined in claim 1, the projector is equipped with a cover mechanism that can close and open the projection lens opening formed in the front end of the case and the lens adjustment opening formed in one end of the case adjacent the front end, so that zooming and focusing of the projection lens unit as well as projection can be performed by uncovering these windows with the cover mechanism. Moreover, the projection lens unit can be protected against dust and external mechanical shocks by the cover mechanism when the unit is not in use by closing the projection lens opening and lens adjustment opening by the cover mechanism.

In the arrangement where operability of the projection lens is improved on one hand by the lens adjustment opening formed in the upper end of the case, a problem then arises on the other hand when the video display apparatus is used in a classroom equipped with a blackboard, since chalk dust may deposit in the apparatus through the lens adjustment opening. This problem can be advantageously solved by the slide cover of invention as defined in claim 2. In addition, the upper lens adjustment opening is conformed to the lens adjustment members that are manipulated in the transverse direction, and the slide cover has an inverted L-shape cross section and is freely slidable in the transverse direction to shut and open the front projection lens opening and upper lens adjustment opening, so that the slide cover can be shut and open in just the same simple manner as the manipulation of the lens adjustment members.

In accordance with the invention as defined in claim 3, the cover mechanism is made of a transparent or translucent material that on-off condition of the light source can be easily checked even when the projection lens opening is closed by the cover mechanism, which helps prevent the operator from forgetting to turn off the light source. Moreover, when the cover mechanism is made of a transparent material, projection can be performed with the cover mechanism shut. A projection type video display apparatus is not only installed on a floor and table but also suspended from a ceiling, depending on the intended use. In the latter case, it is often the case that manipulation of the cover mechanism is difficult. Nevertheless, with the projector configured as described above, manipulation of the cover mechanism is not necessary to perform image projection, so that video projection can be conveniently performed with the cover mechanism shut. Thus, the transparent cover mechanism adds improved usability to the display apparatus.

In the cover mechanism of the invention as defined in claim 4, the slide cover can be held in position by the slide holder so as to keep the projection lens opening and lens adjustment opening open, so that the cover mechanism will not inadvertently shut and hinder projection of images through the projection lens unit.

In accordance with the invention as defined in claim 5, the slide holder can hold the slide cover in position so as to keep the projection lens opening and lens adjustment opening closed, so that the slide holder can prevent the slide cover from inadvertently open and prevent dust from depositing in the projection lens opening and lens adjustment opening.

In the cover mechanism of the invention as defined in claim 6, the slide holder can hold the slide cover in position so as to close the lens projection opening and lens adjustment opening, so that the slide holder can prevent the slide cover from being inadvertently opened, prevent dust from depositing in the openings, and prevent the projection lens unit and lens adjustment members from being damaged by external objects, and prevent inadvertent dust deposition in the openings.

In accordance with the invention as defined in claim 7, the projection lens opening and lens adjustment opening are formed independent, i.e. formed as separate openings, thereby rendering the case stronger as compared with a case having communicating openings.

In accordance with the invention as defined in claim 8, the slide cover is securely held between the slide holder and the case. Yet the slide cover can slide smoothly and in a stable manner with the protruding rail of the slide holder engaged in the elongate groove.

In accordance with the invention as defined in claim 9, when the slide cover is conditioned to close the projection lens opening and lens adjustment opening, the resilient pawl formed at the open end of the elongate groove of the slide cover is firmly stopped by the stopper formed on the slide holder, thereby causing the slide cover to be firmly shut in a stable manner.

In accordance with the invention as defined in claim 10, when the slide cover is conditioned to open the projection lens opening and lens adjustment opening, the resilient pawl formed at the open end of the recess of the slide cover is firmly stopped by the stopper formed on the slide holder, thereby causing the slide cover to be firmly opened in a stable manner.

### BRIEF DESCRIPTION OF DRAWINGS

FIGS. 1(a) and 1(b) show in perspective a projection type video display apparatus in the form of a liquid crystal projector in accordance with a first embodiment of the invention, as viewed from an upper front point in space with respect to the projector, with openings closed and opened, respectively.

FIGS. 2(a)-(b) show in front elevation the liquid crystal projector with the openings closed and open, respectively; FIGS. 2(c)-(d) show in front elevation the projector with the openings closed and open, respectively; FIG. 2(e) shows a side elevation of the projector.

FIGS. 3(a)-(e) show cross sections of the projector: particularly, FIG. 3(a) is a cross taken along line A-A′ of FIG. 2(c); FIG. 3(b), along line E-E′ of FIG. 2(d); FIG. 3(c), along line B-B′ of FIG. 2(a); FIG. 3(d), along line D-D′ of FIG. 2(b); and FIG. 3(e), along line C-C′ of FIG. 2(c).

FIG. 4(a) shows in exploded perspective a main portion of the projector with the bottom plate of the case removed; FIGS. 4(b) and 4(c) show in perspective the main portion with the slide cover opened and closed, respectively.

FIG. 5 shows in perspective a slide cover and a slide holder assembled together for use with a projection type video display apparatus in the form of a liquid crystal projector in accordance with a second embodiment of the invention.

FIG. 6 shows in exploded perspective the slide cover and the slide holder of the liquid crystal projector shown in FIG. 5.

FIG. 7 shows in exploded perspective the slide cover of the liquid crystal projector as viewed from the backside thereof.

FIG. 8 shows in perspective the projector case as viewed from the backside thereof, with the projection lens opening and lens adjustment opening closed.

FIG. 9 shows in perspective the projector case as viewed from the backside thereof, with the projection lens opening and lens adjustment opening open.

FIG. 10 shows in perspective an alternative slide cover of the liquid crystal projector, as viewed from the backside thereof.

### NOTATIONS

1 projector case
1a front end
1b upper end
1c bottom plate
2 projection lens
3 projection lens opening
4 adjustment dial (manipulation member)
5 lens adjustment opening
6 cover mechanism
7 slide cover
7a front cover section
7b upper cover section
7c elongate guide slits
7d protrusions
8 guide screws

### BEST MODE FOR CARRYING OUT THE INVENTION

With a minimum number of protective parts, the present invention achieves the object to protect the projection lens unit of a projector against dust and external mechanical shocks that can enter through a projection lens opening formed in the front end of the projector case and the lens adjustment opening formed adjacent the projection lens opening.

### First Embodiment

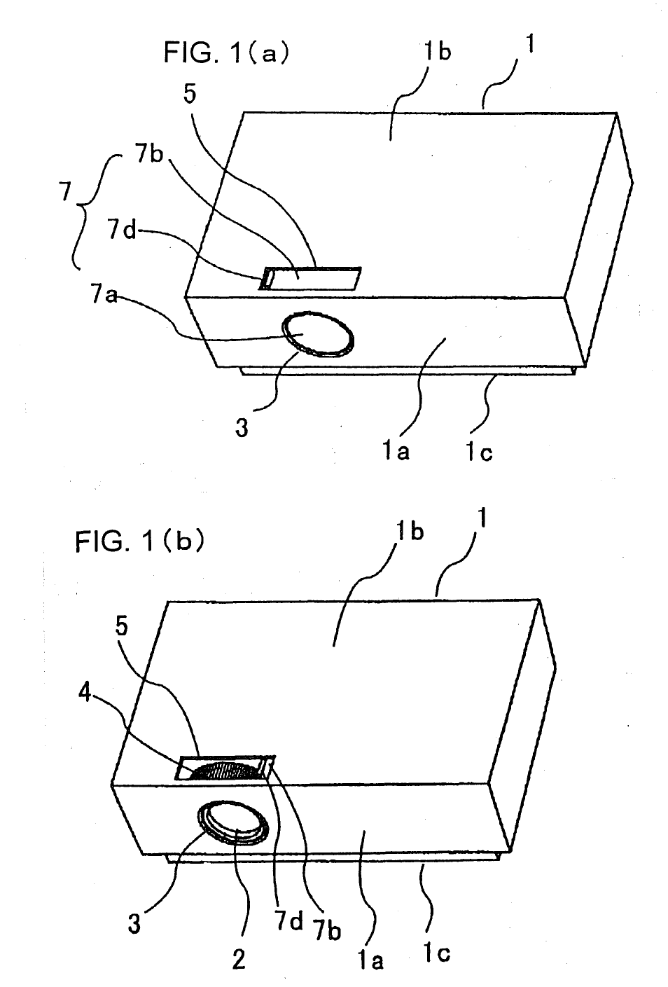

Referring to FIGS. 1 through 4, a first embodiment of the invention will now be described in detail.

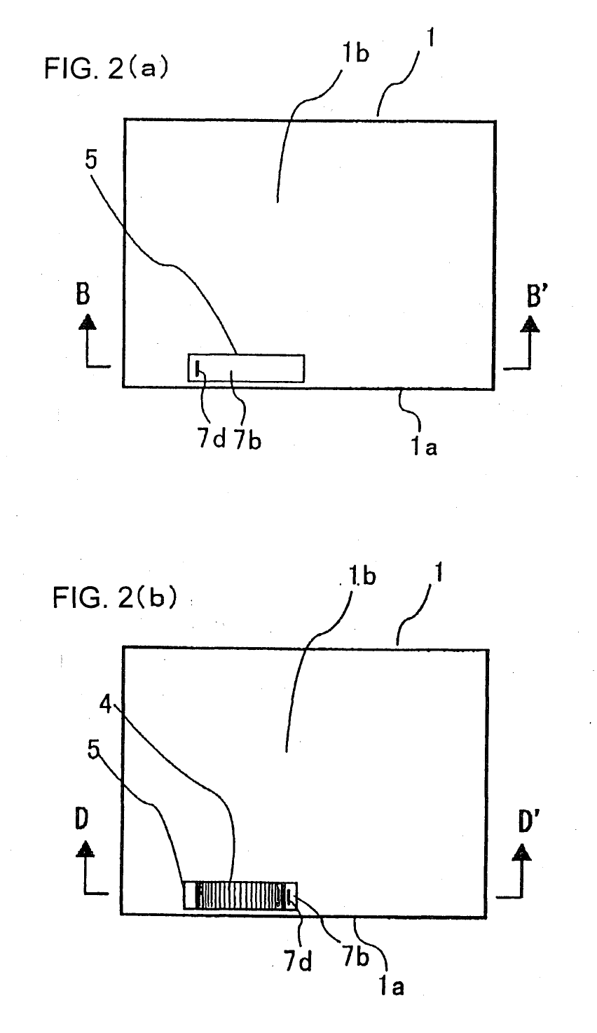

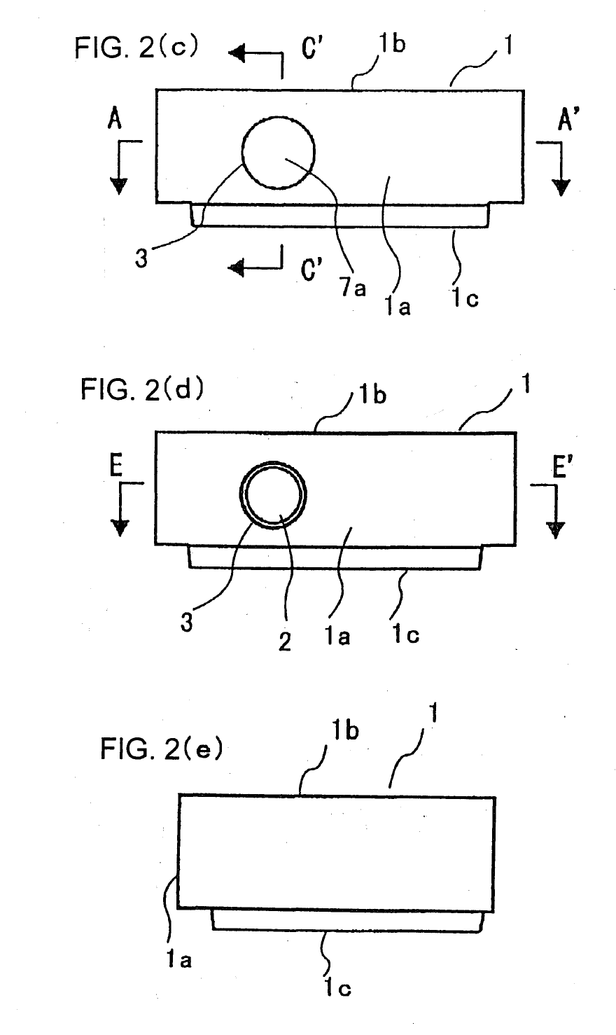

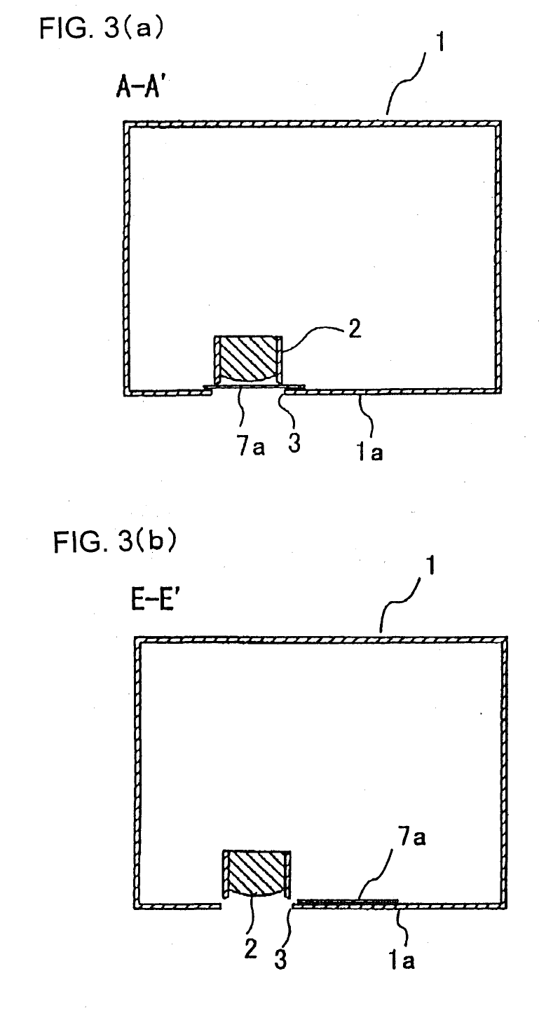

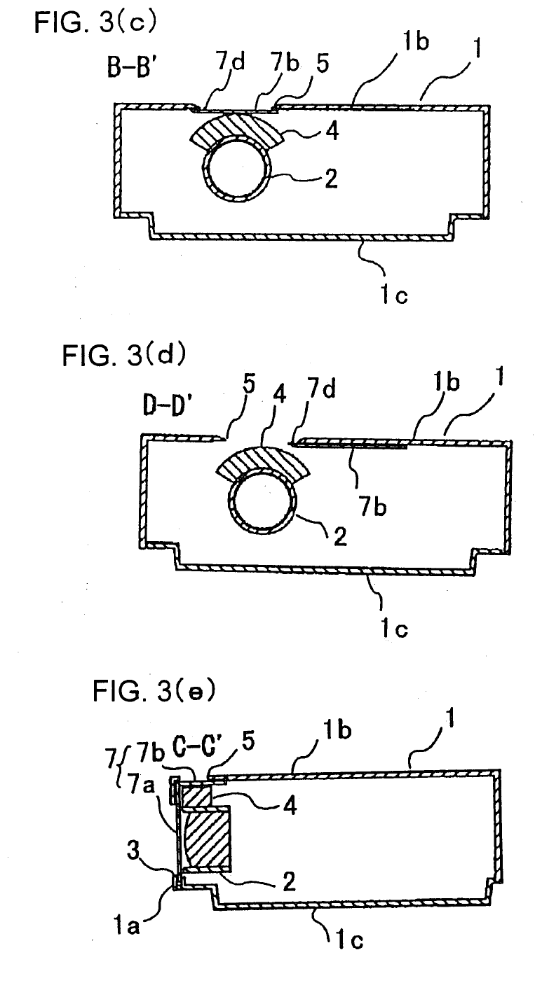

FIG. 1 shows in perspective a liquid crystal projector of the invention as viewed from an upper front point in space relative to the projector, with its openings closed (FIG. 1(a)) and opened (FIG. 1(b)). FIGS. 2(a)-(b) are plans when the openings are closed and open, respectively; FIGS. 2(c) and (d) are front elevations when the openings are closed and open, respectively; FIG. 2(e) is a side elevation of the projector. FIGS. 3(a)-(e) are cross sections taken along lines A-A′ through E-E′ of FIG. 2.

The case 1 of the liquid crystal projector has a projection lens opening 3 formed in the left side of the front end 1a of the projector to expose therein a projection lens unit 2, and a lens adjustment opening 5 formed in the upper end 1b adjacent the front end 1a in association with the projection lens opening 3 to expose therein lens adjustment members such as a control dial 4 for zooming and/or focusing the projection lens unit 2.

The lens adjustment opening 5 is a rectangular shape that extends in the transverse direction to allow a finger to move in the transverse directions to rotate the adjustment dial 4. The adjustment dial 4 and the lens adjustment opening 5 are separated by a space to allow the upper cover section 7b of a slide cover 7 (described in detail below) to move between the adjustment dial 4 and the lens adjustment opening 5 as shown in FIGS. 3(c)-(e). Although the adjustment dial 4 is disposed below the lens adjustment opening 5, the adjustment dial 4 can be well manipulated with the tip of an index finger for example inserted in the lens adjustment opening 5.

The projection lens opening 3 and lens adjustment opening 5 can be simultaneously closed and opened in a single step by a cover mechanism 6 which comprises the slide cover 7 having a front cover section 7a integral with the upper cover section 7b. The cover mechanism is slidably arranged inside the case 1.

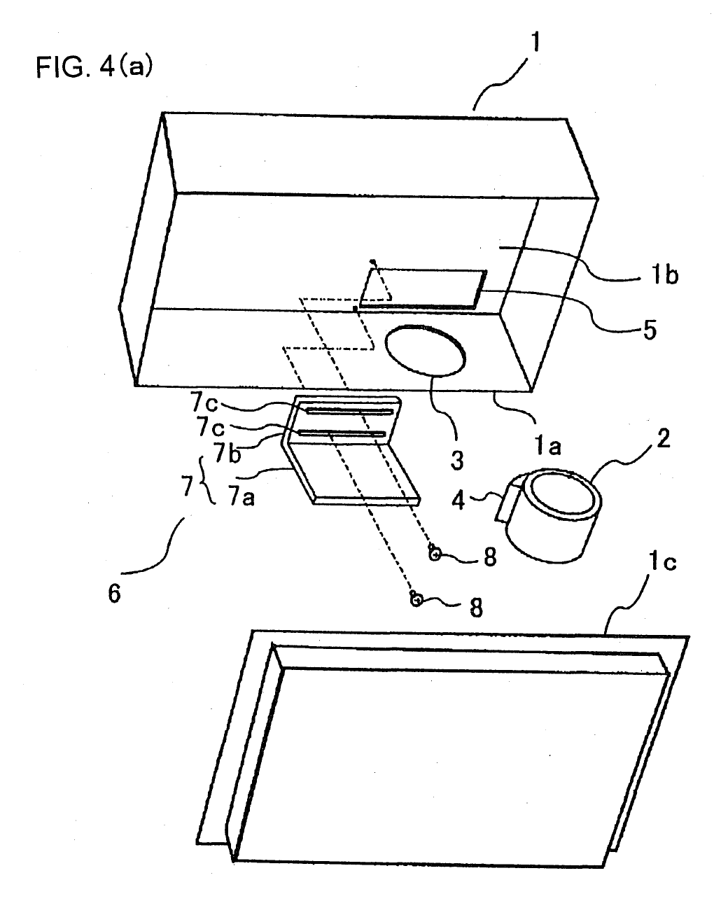

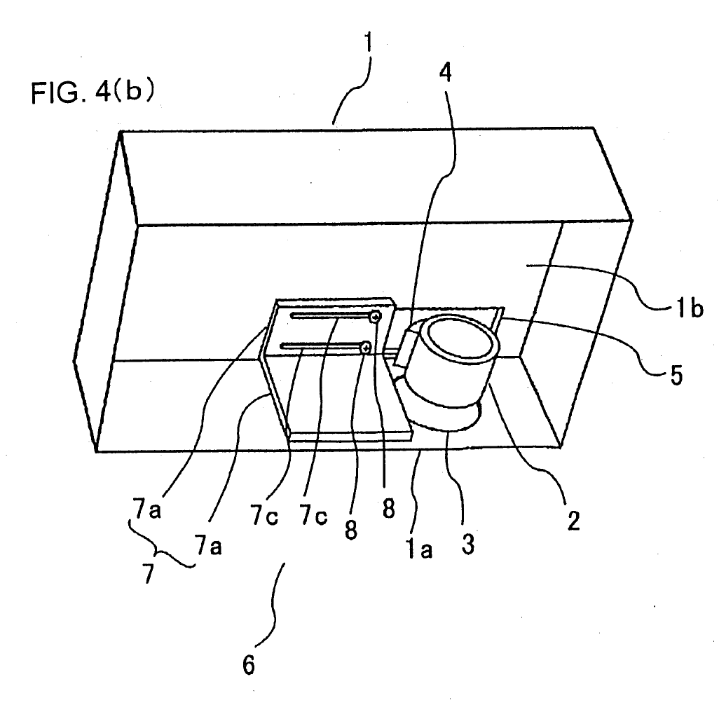

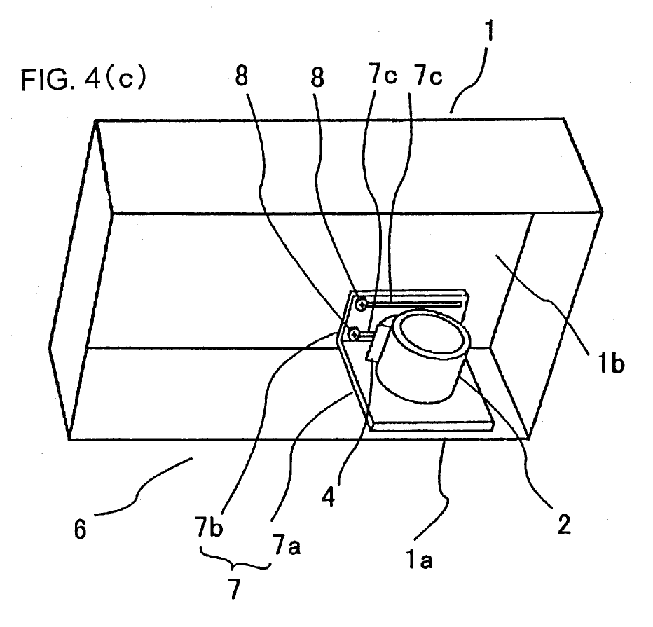

Referring to FIGS. 4(a)-(c), details of the cover mechanism 6 will now be described. FIG. 4(a) shows in perspective a main portion of the cover mechanism 6 and the case 1 with the bottom plate lc of the case 1 dismantled. FIGS. 4(b)-(c) show in perspective the main portion of the cover mechanism 6 with the slide cover 7 opened and shut, respectively. As shown in FIGS. 4(a)-(c), the slide cover 7 of the cover mechanism 6 has an inverted L-shape cross section so that it can shut and open the projection lens opening 3 of the front end 1a and the lens adjustment opening 5 of the upper end 1b of case 1.

The slide cover 7 is made of a transparent or translucent material. The upper cover section 7b for shutting and opening the lens adjustment opening 5 has along a front edge and a rear edge thereof a pair of elongate guide slits 7c for slidably securing the slide cover 7 with a pair of screws 8 passing through the elongate guide slits 7c and fixed on one side of the lens adjustment opening 5. As a consequence, the slide cover 7 is freely slidably in the transverse direction.

As shown in FIGS. 1 and 2, the upper cover section 7b is provided at one transverse end thereof with a protrusion 7d that protrudes into the lens adjustment opening 5 to serve as a finger grip usable in sliding the slide cover 7 in the transverse direction. The finger grip also defines the slidable range of the upper cover section 7b.

In the example shown herein, the elongate guide slits 7c are formed in the upper cover section 7b of the slide cover 7 and the guide screws 8 are provided at one transverse end of the lens adjustment opening 5. Alternatively, the elongate guide slits may be provided in the front cover section 7a of the slide cover 7 and the guide screws provided at one end of the front projection lens opening 3. Further, guide grooves for guiding the upper and lower edges of the slide cover 7 may be provided.

In operation, the slide cover 7 is touched with an index finger for example on the protrusion 7d formed on the closed upper cover section 7b, and fully moved in the transverse direction, away from its closing position, as shown in FIG. 1(a), to thereby open the projection lens opening 3 and lens adjustment opening 5 as shown in FIG. 1(b).

Then, the liquid crystal projector is powered on to turn on its ultra-high-pressure mercury lamp (not shown). The light emitted from the light source is split into three beams of R, G, and B colors by means of an optical system (not shown). The R, G, and B beams are modulated by video signals in three associated liquid crystal panels, and then synthesized by a color synthesizing prism into a full-color beam of light before the beam is projected by the projection lens unit onto a screen. Since the lens adjustment opening 5 is also opened, the projection lens unit 2 can be zoomed and/or focused by manually operating the adjustment dial 4 exposed in the lens adjustment opening 5 with a finger.

On the other hand, not in operation, the light source is turned off, and the slide cover 7 is reversed in the transverse direction, from its open position back to the closing position, by manipulating the protrusion 7d with a finger, thereby closing the projection lens opening 3 and lens adjustment opening 5 as shown in FIG. 1 (b). Thus, the projection lens unit is protected against dust and mechanical shocks that may otherwise enter the projection lens opening 3 and the lens adjustment opening 5.

Although the upper lens adjustment opening 5 formed in the upper end 1b of the case 1 provides an improvement in operability of the projection lens unit, a problem may arise in that chalk dust can deposit in the lens adjustment opening 5 when the projector is installed in a class room where chalk is used on a blackboard, unless the opening is closed. This problem is solved in this embodiment by the slide cover 7, since it will shut out chalk dust from the upper lens adjustment opening 5.

It is noted that the lens adjustment opening 5 is formed in the top end 1b in conformity with a finger manipulating the adjustment dial 4 in the transverse direction, and that the slide cover 7 has an inverted L-shape cross section and is slidable over the lens adjustment opening 5 and projection lens opening 3. Thus, both of the upper lens adjustment opening 5 and projection lens opening 3 can be opened and closed in an extremely simple manner as in manipulation of the adjustment dial 4.

Since the slide cover 7 is made of a transparent or translucent material, on-off condition of the light source can be easily checked if the projection lens opening 3 is covered with the slide cover 7.

Further, when the slide cover 7 is made of a transparent material, it is possible to perform projection with the slide cover 7 shut. Projection type video display apparatuses are installed on a floor or a desk, and occasionally suspended from a ceiling, depending on the intended use. One of the merits of such arrangement as described above is that the projector is operable with the slide cover 7 shut and manipulation of the slide cover 7 is not necessary. This is especially convenient when such projection type video display apparatus is suspended from the ceiling and operation of the slide cover 7 is difficult.

Although the adjustment dial 4 for zooming and focusing is not operable when the slide cover 7 is shut, it does not matter at all, since the display apparatus is fixed in position when suspended from the ceiling.

In order to prevent distortion of projected images that arises from the thermal deformation of the slide cover 7 as it is shut and heated by a high-intensity light source during projection, it is important to provide the slide cover 7 made of a heat-resistant transparent material such as a heat-resistant glass.

In the example shown herein where lens adjustment opening 5 and the projection lens opening 3 are independent (i.e. separated), the case 1 has a higher strength than those having a lens adjustment opening that communicate with the projection lens opening.

In the embodiment above, only a manually operable cover mechanism 6 has been described. However, it would be apparent that the cover mechanism could be mechanically or electrically driven. For example, noting temperature rise in the cover mechanism during projection, the cover mechanism 6 can be opened by a motor or shape-memory alloy when the light source is turned on (during projection) and shut otherwise.

In the embodiment above, the lens adjustment opening 5 has been described to be formed in the upper end 1b of the case 1. Alternatively, the opening 5 may be formed in the bottom end or a sidewall adjacent the front end 1a of the case 1. When the lens adjustment opening is formed in the bottom end of the case, the cover mechanism may have an inverted configuration with respect to the one for the upper lens adjustment opening 5. When the lens adjustment opening is formed in one of the opposite sides of the case 1 having a sufficient height, a slide cover similar to the one for the upper opening 5 may be used. When the height of the side is too small to allow for vertical motion of the slide cover, a flexible or arcuate slide cover may be used.

### Second Embodiment

Referring to FIGS. 5 through 9, there is shown a second embodiment of the invention. Components which are the same in the first and second embodiments are respectively referred to by the same reference numerals.

In contrast to the first embodiment where the slide cover 7 has a simple sliding structure, the second embodiment has a slide holder 9 for holding a slide cover 70 shut and open so as to keep the projection lens opening 3 and lens adjustment opening 5 closed and open, respectively.

As shown in FIG. 5, the slide cover 70 has a generally L-shape configuration that can extend over an entire region of a generally L-shape slide holder 9. The slide cover 70 is freely slidable on the slide holder 9.

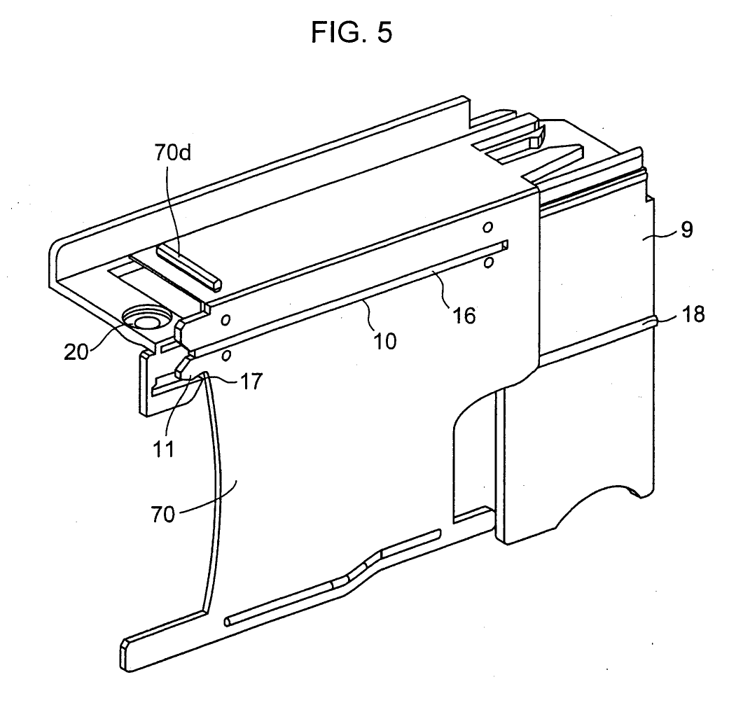

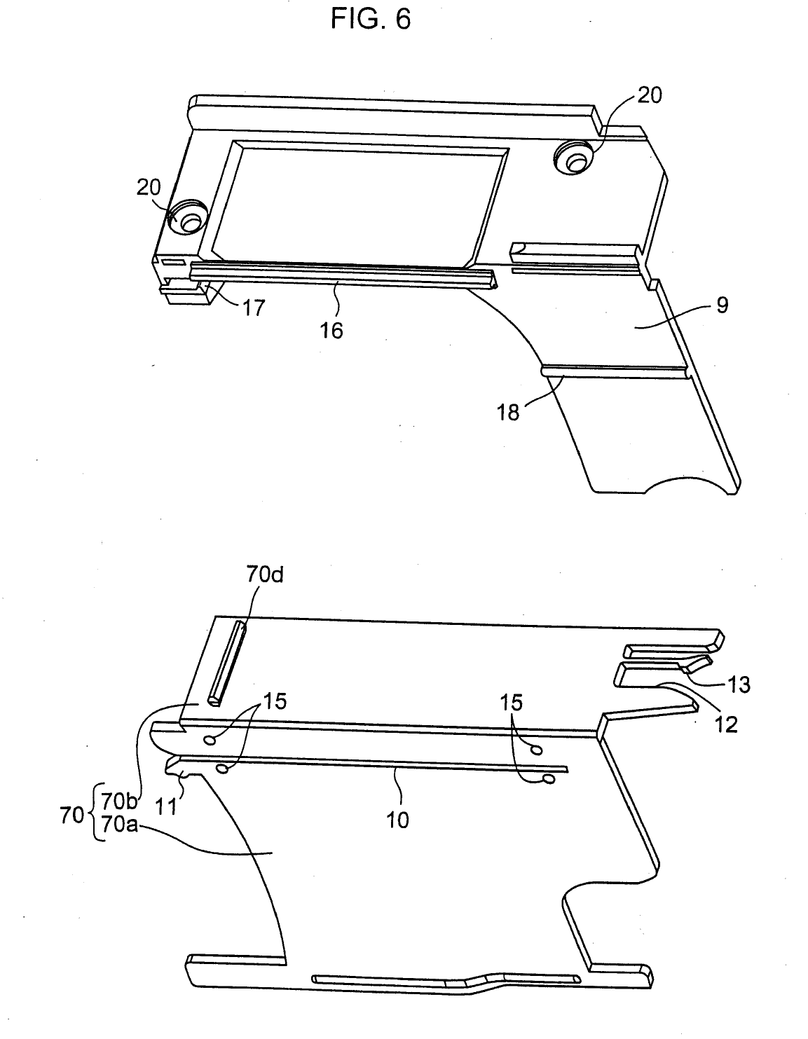

As shown in FIG. 6, the slide cover 70 has:

a generally U-shape elongate groove 10 extending in the sliding direction of the front cover section 70a of the slide cover 70 and having an open end;

a resilient pawl 11 formed at the open end of the elongate groove 10 to protrude outwardly in the direction perpendicular to the elongate groove 10; a U-shape recess 12 having an open end at one end of the upper cover section 70b remote from the pawl 11; and

a resilient engagement pawl 13 protruding from one of the opposite walls of the recess 12 towards the other.

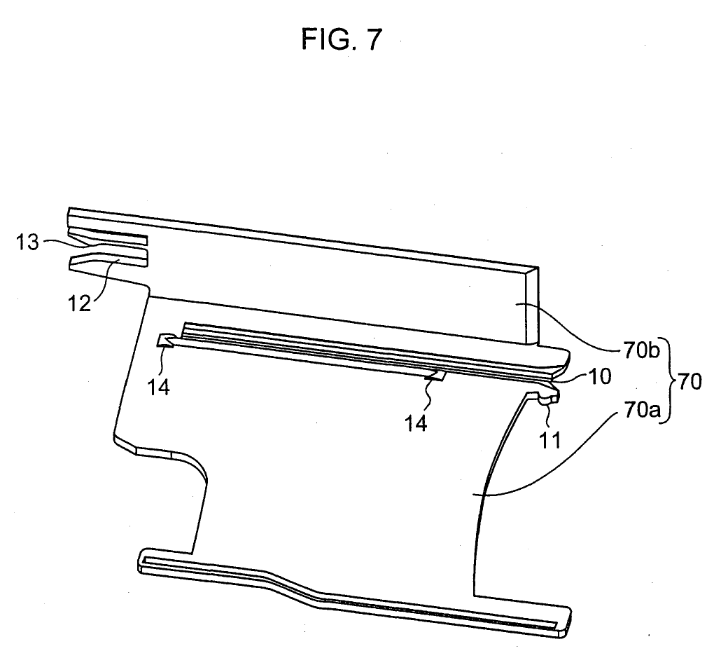

As shown in FIG. 7, a multiplicity of protrusions 14 are formed on the surface of the front cover section 70a facing the slide holder 9. Similarly, a multiplicity of protrusions 15 are formed on the surface of the front cover section 70a facing the case 1 as shown in FIG. 6. These protrusions allow the slide cover 70 to easily slide between the slide holder 9 and the case 1.

As shown in FIG. 6, the slide holder 9 has a protruding rail 16 that can slidably engage with the elongate groove 10 of the slide cover 70, a resilient stopper 17 that detachably engages with the pawl 11 of the slide cover 70, a protruding rail 18 formed on the front cover section 70a of the slide cover 70 to extend in the sliding direction thereof, and threaded sections 20 to be connected to the engagement bosses 19 formed on the case 1.

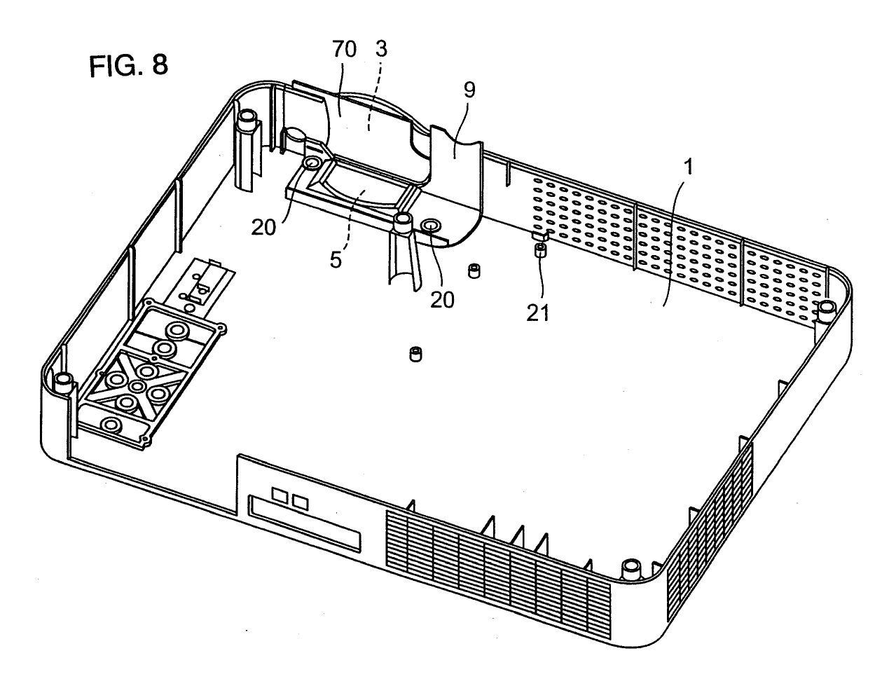

The slide cover 70 is coupled to the slide holder 9 by fitting the protruding rail 16 in the elongate groove 10 as shown in FIG. 5, and the slide holder 9 is mounted on the case 1 by fixing the threaded sections 20 to the engagement bosses 19 with screws (not shown) as shown in FIG. 8, thereby slidably mounting the slide cover 70 on the case 1 via the slide holder 9.

The slide cover 70 is guided by the protruding rail 16 of the slide holder 9 as it slides on the slide holder 9. Because of the protruding rail 18 extending in the sliding direction of the slide cover 70 on the slide holder 9, and because of multiple protrusions 14 protruding from the slide cover 70 towards the slide holder 9, the slide cover 70 comes into contact with the slide holder 9 only partially, rather than coming into contact with the entire surface of the slide holder 9. Because of the multiple protrusions 15 formed on the slide cover 70 facing the case 1, the slide cover 70 will never come into contact entirely with the case 1. This ensures smooth sliding motion of the slide cover 70 when moved with a finger placed on a protrusion 70d formed on the slide cover 70 and appearing in the lens adjustment opening 5.

When the slide cover 70 is conditioned to close the projection lens opening 3 and the lens adjustment opening 5 as shown in FIG. 8, the pawl 11 of the slide cover 70 engages with the stopper 17 of the slide holder 9 as shown in FIG. 5 and is held there, keeping the projection lens opening 3 and lens adjustment opening 5 closed. Thus, the slide cover 70 is prevented from being inadvertently opened and from allowing deposition of dust in the projection lens opening 3 and lens adjustment opening 5.

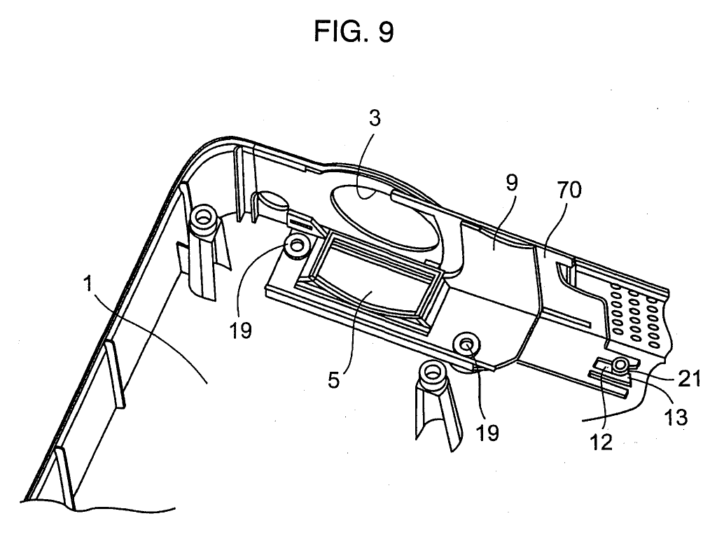

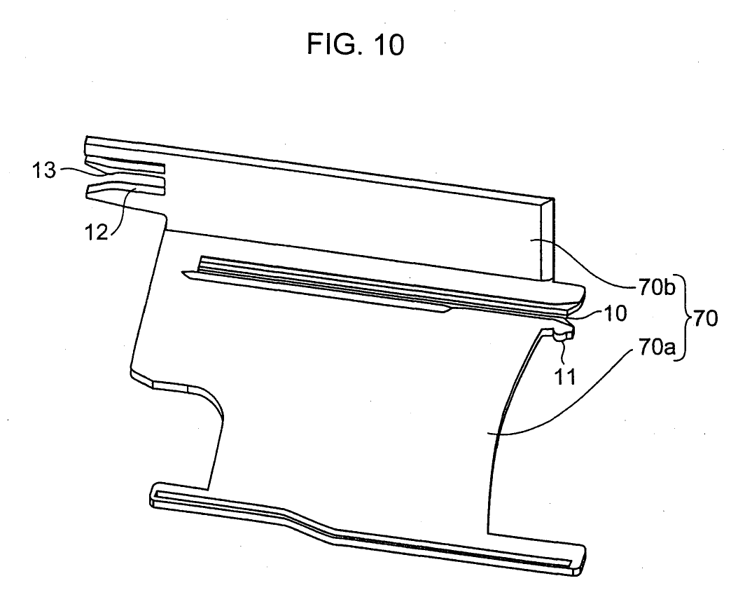

When the slide cover 70 is conditioned to open the projection lens opening 3 and the lens adjustment opening 5 as shown in FIG. 9, the engagement pawl 13 of the slide cover 70 engages with a stopping boss 21 formed on the case 21 and is held there, keeping that condition. Thus, the slide cover 70 is prevented from inadvertently shut the openings and from hindering projection.

In the second embodiment described above, the slide cover 70 is provided with the multiple protrusions 14 formed on the side facing the slide holder 9. However, the slide cover 70 may have no such protrusions 14, since the protruding rail 16 formed on the slide holder 9 will prevent the slide cover 70 from coming into contact entirely with the slide holder 9.

In the first and second embodiments, the invention has been described with reference to projection type video display apparatuses in the form of liquid crystal projectors utilizing liquid crystal panels. However, the invention can be equally applied to different types of projection type video display apparatuses that utilize other image generation systems, including a projector employing DLP (Digital Light Processing, which is a registered trademark of Texas Instruments (TI), Inc.).

1. A projection type video display apparatus for modulating light emitted from a light source based on video signals to display an image through projection of the modulated light via a projection lens unit, comprising:
a case of the apparatus having a front end formed therein with a projection lens opening to which the projection lens unit is exposed, an upper end adjacent to the front end and formed therein with a lens adjustment opening;
a lens adjustment member exposed to the lens adjustment opening and rotated to adjust zooming and/or focusing the projection lens unit;
an L-shaped slide cover formed integrally with a front cover section for slidably covering the projection lens opening, an upper cover section for slidably covering the lens adjustment opening and a finger grip projecting from the lens adjustment opening for operating the slide cover; and
an L-shaped slide holder attached to the case and fixed to a portion of the case in a neighborhood of the lens adjustment opening;
wherein the slide cover is configured to be slidable relative to the slide holder in a state extending over an entire area of the slide holder and slidably supported inside the case and between the case and the slide holder in a same direction as a rotating direction of the lens adjustment member.

2. A projection type video display apparatus according to claim 1 is provided with a state holding mechanism held in a state in which the slide cover has exposed the projection lens unit and the lens adjustment member to the case or covered the projection lens unit and the lens adjustment member.

3. A projection type video display apparatus according to claim 1, wherein the slide cover is made of a transparent or translucent material.

4. A projection type video display apparatus according to claim 2, wherein the slide cover is made of a transparent or translucent material.
